(19) United States
(12) Patent Application Publication
(10) Pub. No.: US 2003/0180541 A1
(43) Pub. Date: Sep. 25, 2003

(54) Topcoat compositions, substrates coated therewith and method of making and using the same

(76) Inventors: Kirit N. Naik, Mentor, OH (US); Stefanie J. Rose, Painesville, OH (US); Curtis E. Hess, Painesville, OH (US); Martha Waters, Fairport Harbor, OH (US)

Correspondence Address: William C. Tritt, Renner, Otto, Boisselle & Sklar, LLP, Nineteenth Floor, 1621 Euclid Avenue, Cleveland, OH, 44115, US

(21) Appl. No.: 10/357,593

(22) Filed: Feb. 4, 2003

Related U.S. Application Data
(60) Provisional application No. 60/354,190, filed on Feb. 4, 2002.

(51) Int. Cl. B32B 27/00

(52) U.S. Cl. 428/423.1

(57) ABSTRACT

This invention relates to a topcoat composition comprising (i) a mixture of (A) at least one polyurethane and (B) at least one durability improving polymer, (ii) a mixture of two or more acrylic urethanes, or (iii) a combination of (i) and (ii). The invention also relates to ink receptive sheets comprising a substrate containing a topcoat derived from the topcoat compositions. The topcoat compositions of the present invention provide a flexible and durable substrate that allows printing with solvent based inkjet inks used with non-vented printers and UV inkjet inks.

### CROSS REFERENCE TO RELATED APPLICATION

This application claims priority from provisional application U.S. Serial No. 60/354,194, filed Feb. 4, 2002. The provisional application is hereby incorporated by reference in its entirety.

### FIELD OF THE INVENTION

This invention relates to ink-receptive topcoats, especially topcoats which are receptive to non-vented solvent inkjet inks and UV curable ink jet inks. These topcoats are useful on substrates used with non-vented printers.

### BACKGROUND OF THE INVENTION

Ink-jet technology utilizes a liquid based delivery system in which the ink pigments or dyes are delivered to a substrate together with a liquid. The substrate usually has a topcoat which contains at least one absorbent material to remove the liquid of the ink-jet ink. The conventional ink-jet printing technology is based on liquid based inks, such as water, solvent or oil based inks. Typically the coatings include resins and/or fillers which are able to swell and absorb liquid. Examples of these resins include gelatin, polyvinyl pyrrolidone, and polyvinyl alcohol.

Solvent based inkjet inks typically utilize a solvent that is harmful if released into the environment. These inks are used with printers that have special environmental adaptations such as venting or heating to remove the solvent and prevent it from adversely effecting the environment. Aqueous inkjet inks are water based and therefore do not pose the same environmental concerns. Often in narrow format graphics applications, aqueous inkjet inks are used. However, the demands for a wide format graphics are not met by aqueous inkjet inks topcoats. In particular, these inks do not provide the quality of printing necessary.

Topcoat compositions have been used for both solvent and water based or aqueous based inkjet inks to improve adhesion of the ink and to help manage the solvent or water present in the inkjet ink. The coatings must be able to provide a good adhesion surface for the ink as well as have flexibility and adhere to the substrate. The demands of wide format graphics are such that topcoats typically used for these aqueous inkjet inks are not suitable for wide format graphics. The coatings tend to crack and flake because they lack flexibility and durability.

New inks are being developed which utilize environmentally friendly solvents. These solvents do not require the venting and special environmental equipment previously needed for solvent based inkjet inks. It is desirable to have a topcoat composition which provides good adhesion for use with non-vented inkjet inks.

UV-cured ink-jet printing is a relatively new printing technology that uses inks that are cured by ultraviolet radiation. Unlike solvent ink-jet inks, no liquid, such as water, solvent or oil, is necessary as a carrier for the dyes or pigments of the inks. Accordingly, no strong absorbing coatings or additional thermal drying steps are necessary to set these UV curable inks on the printing medium. A need exists for a topcoat that provides a good medium for the UV curable ink-jet inks.

### SUMMARY OF THE INVENTION

This invention relates to a topcoat composition comprising (i) a mixture of (A) at least one polyurethane and (B) at least one durability improving polymer, (ii) a mixture of two or more acrylic urethanes, or (iii) a combination of (i) and (ii).

The invention also relates to ink receptive sheets comprising a substrate having a topcoat derived from the topcoat compositions. The topcoat compositions of the present invention provide a flexible and durable substrate that allows printing with solvent based inkjet inks used with non-vented printers and UV inkjet inks.

In one embodiment, the invention relates to a topcoat composition comprising (A) at least one polyether urethane, polyester polyurethane, acrylic urethane copolymer, or mixtures of two or more thereof and (B) at least one polyacryl, polymethacryl, a thermoplastic polymer of ethylene or propylene, a polyester, a styrene acryl copolymer and mixtures of two or more thereof.

In another embodiment, the invention relates to a topcoat composition comprising a combination of two or more acrylic urethanes. In another embodiment, this topcoat composition further comprises (B) at least one durability improving polymer.

In another embodiment, the invention relates to a method of printing comprising the steps of (1) providing a printable substrate having at least one surface coated with a coating derived from a topcoat composition comprising: (A) at least one polyurethane and (B) at least one durability improving polymer, (2) printing on the topcoat composition with a non-vented printer using a solvent based inkjet ink or UV curable inkjet ink.

### DETAILED DESCRIPTION OF THE INVENTION

The present topcoat compositions are useful with solvent inkjet inks and UV inkjet inks used with non-vented printers. These solvent based inkjet inks are those that use solvents which are acceptable to the environment. These inks are used on printers, both narrow and wide format, which do not have special venting, heating or other environmental equipment to prevent the release of the organic solvent into the environment. An example of a useful solvent inkjet ink used with a non-vented printer is SL-BK ink available from Roland Corporation. The non-vented printer is Roland Soljet printer.

UV-curable inks are also useful with the present topcoat compositions. UV ink systems are typically 100 percent solids and contain low VOCs. These systems are more environmentally-friendly than most conventional ink systems. These UV inks are known to those in the art and commercially prepared by Sericol, Sunjet, and Inkware. UV ink printers employing UV curable inks are also known to those in the art and include those printer made by Legget and Platt, Durst, Inca, and Vutek.

The topcoat compositions are applied to any substrate to make an ink receptive sheet. The substrate may be a paper or a polymeric substrate. The paper substrates may have polymeric coatings on them such as polyethylene coated paper. The polymeric substrates may be a monolayer or multilayer substrates. The paper and polymeric substrates are known to those skilled in the art.

The materials useful as the substrate layer include film based substrates, such as polyolefin films, polyester films, polyamide films, durable banner material and polyurethane films. These materials may be the substrate or layer of a substrate that contacts the topcoat. In one embodiment, the substrate is coated with film forming materials derived from polyolefins, polyesters, polyamides and polyurethanes. Substrates which may be used includes film stocks such as Fasclear, Primax, Mirage and Graphics XL cast vinyl, MX calendared vinyl many of which are available from Avery Dennison Corporation. Examples of useful substrates includes polyester films, such as a 7 mil polyethyleneterephthalate (PET) film and 4 mil white PET film; vinyl halide film, such as 3.2 mil polyvinyl chloride film, including those which are calendared; and 4 mil polyethylene film.

Although not limited to wide format graphic printers, the coatable, ink-receptive compositions of the present invention are particularly applicable to wide format products. Wide format products are generally manufactured as wide rolls (24 or more inches wide), and are roll-fed into large printers for imaging. They are typically employed in commercial settings, and include, for example, movie theater posters, outdoor signage, large advertisements, and the like. Narrow format products, by contrast, are generally manufactured as narrow rolls or individual sheets, and can be roll-fed or sheet-fed into printers for imaging. They are typically used in the office or home, and include, without limitation, computer printer paper, labels, transparencies, and the like.

Wide format and narrow format ink-receptive products differ not only in size, but also in ink capacity, durability, and other properties, and are often exposed to different use environments. For example, wide format products may encounter more ink per unit area when run through certain commercial printers. Problems with poor image quality, color bleed, and smearing are typical problems in wide format graphics applications.

The ink receptive coating may be used in front lit, back lit or combination applications. In back lit applications, the substrate generally contains a ink receptive layer and optionally an opacity improving layer. When used in a front lit application, the substrate has the ink receptive layer and an adhesive layer.

The topcoat compositions comprise (i) a mixture of (A) at least one polyurethane and (B) at least one durability improving polymer, (ii) a mixture of two or more acrylic urethanes, or (iii) a combination of (i) and (ii). The topcoat derived form the topcoat composition will generally have a thickness from about 0.01 to about 40, or from about 0.1 to about 30, or from about 0.3 to about 20, or from about 0.5 to about 15, or from about 1 to about 10 g/m². In one embodiment, the topcoat will have a thickness from about 1 to about 40, or from about 10 to about 30 g/m². When the topcoat is used with a UV printer, then in one embodiment, the topcoat has a thickness form about 0.5 to about 15, or from about 1 to about 10 g/m². When the topcoat is used with a non-vented solvent ink, then the topcoat has a thickness from about 10 to about 40, or from about 15 to about 35, or from about 20 to about 30 g/m². Here, as well as elsewhere in the specification and claims, all range and ratio limits may be combined.

(A) Polyurethane

The polyurethane (A) may be an aliphatic or aromatic polyurethane, or a mixture of two or more aliphatic polyurethanes or aromatic polyurethanes. Mixtures of aliphatic and aromatic polyurethanes may also be used. Typically (A) composition is present in an amount from about 5% to about 95%, or from about 25% to about 90%, or from about 30% to about 80%, or from about 35% to about 65%, or from about 40% to about 60% by weight of the solids of the coating composition. The polyurethane is typically the reaction products of the following components: (A) a polyisocyanate having at least two isocyanate (—NCO) functionalities per molecule with (B) at least one isocyanate reactive group such as a polyol having at least two hydroxy groups or an amine. Suitable polyisocyanates include diisocyanate monomers, and oligomers. Aliphatic polyisocyanates include 1,6-hexamethylene diisocyanate (HMDI) and its isocyanurate-containing derivatives; cycloaliphatic polyisocyanates such as 4,4′-methylene bis(cyclohexyl isocyanate) (H₁₂ MDI), cyclohexane 1,4-diisocyanate and its isocyanurate derivatives; aromatic polyisocyanates such as 4,4′-diphenylmethane diisocyanate (MDI), xylyene diisocyanate (XDI), toluene diisocyanate (TDI), isophorone diisocyanate (IPDI), 1,5-naphthalene diisocyanate (NDI), 4,4′,4″-triphenylmethane diisocyanate, and their isocyanurate-containing derivatives. Mixtures or the reaction products of polyisocyanates can be used. Polyisocyanates contain the reaction products of these diisocyanate including isocyanurate, urea, allophanate, biuret, carbodiimide, and uretonimine entities.

Examples of polyisocyanates include ethylene diisocyanate, 1,4-tetramethylene diisocyanate, 1,6-hexamethylene diisocyanate (HDI), 1,12-dodecane diisocyanate, cyclobutane, 1,3-diisocyanate, 1-isocyanato-3,3,5-trimethyl-5-isocyanato methyl cyclohexane, bis(4-isocyanato cyclohexyl)methane, isophorone diisocyanate (IPDI), bis(4-isocyanatocyclohexo)methane; 4,4′-methylene-dicyclohexyl diisocyanate; 1,6-diisocyanato-2,2,4,4-tetramethylhexane; 1,6-diisocyanato-2,4,4-trimethylhexane; cyclohexane-1,4-diisocyanate; etc. Desmodur H® from Miles Inc. is described as HDI having an NCO content of 50%, and Desmodur W from Miles Inc. is described as bis (4-isocyanato-cyclohexyl)methane containing 32% of NCO.

In another embodiment, the isocyanate reactive group is a polyol. The polyol (B) may be selected from those commonly found in polyurethane manufacturing. They include hydroxy-containing or terminated polyesters, polyethers, polycarbonates, polythioethers, polyolefins, and polyesteramides. Suitable polyester polyols include hydroxy-terminated reaction products of ethylene glycol, propylene glycol, diethylene glycol, neopentyl glycol, 1,4-butanediol, furan dimethanol, polyether diols, or mixtures thereof, with dicarboxylic acids or their ester-forming derivatives. Polyesters obtained by the polymerization of lactones, such as caprolactone may also be used. Polyether polyols useful for the polyurethane reaction include products obtained by the polymerization of a cyclic oxide including ethylene oxide, propylene oxide or tetrahydrofuran, or mixtures thereof. Polyether polyols include polyoxypropylene (PPO) polyols, polyoxyethylene (PEO) polyols, poly(oxyethylene-co-oxypropylene) polyols, polyoxytetramethylene (PTMO) polyols.

Polycarbonate polyols useful for the polyurethane reaction include the products represented by the reaction products obtained by reacting diols such as 1,3-propanediol, 1,4-butanediol, 1,5-pentanediol, 1,6-hexanediol, diethylene glycol with diaryl carbonates such as diphenyl carbonate, or with phosgene, or with aliphatic carbonate, or with cycloaliphatic carbonate. Commercial polycarbonate diols include Duracarb 120 series aliphatic diols and Durocarb 140 series cyclo aliphatic diols, both of PPG Industries.

The polycarbonate-based polyurethane is typically an aqueous borne dispersion. Aqueous borne dispersions of polycarbonate based polyurethanes and their method of preparation are well-known in the art and has been described in for example GB1549458 and GB1549459. Polycarbonate based polyurethanes for use in connection with the present invention are commercially available and include for example NEOREZ R-986 and NEOREZ.TM. R-985 available from Neo Resins and ALBERDINGK U 911 available from Aberdingk-Boley GmbH, Krefeld, Germany.

In another embodiment, (B) the isocyanate reactive group may be of ionic, ionic precursor or nonionic type. The isocyanate-reactive group include those compounds containing active hydrogen such as diols, polyols, diamines, and polyamines. The isocyanate reactive groups include anionic and cationic types. Anionic types include dihydroxy carboxylic acids such as alpha, alpha-dimethylolpropionic acid (DMPA), diamino carboxylic acids such as 1-carboxy, 1,5-diaminopentane, and 2-(aminoethyl) aminoethyl carboxylic acid; and sulfonate diamines. Anionic type of hydrophilic groups may be the ones that readily form the salts of sulpho, sulfate, thiosulphato, phospho, phosphono, phosphato, or carboxy groups. Examples for cationic type include tertiary amino groups or precursors which readily form salts such as quaternary ammonium, quaternary phosphonium or ternary sulphonium salt groups.

Specific examples of the compounds containing ionic precursor groups and two or more isocyanate-reactive groups include triethanolamine, N-methyldiethanolamine and their oxyalkylation and polyeserification products, trimethylolpropane monophosphate and monosulphate, bis-hydroxylmethyl-phosphonic acid, diaminocarboxylic acids including lysine, cystine, 3,5-diamino benzoic acid, 2,6-dihyroxybenzoic acid, and dihydroxyalkanoic acids including 2,2-dimethylolpropionic acid.

Where a hydrophilic group is unreacted in preparing a polyurethane then a neutralizing compound for the hydrophilic group may be added to the reaction. Amines or ammonia such tertiary amines, such as triethylamine, triethanolamine or N-methylmorpholine, and diethyl amine or triethylamine, are effective in neutralizing carboxylic group and yields a neutralized anionic hydrophilic site on the polyurethane. In one embodiment, a chain extender that reacts with the excess or available isocyanate groups in the presence of aqueous medium and leads to a high molecular weight polyurethane aqueous dispersion. Suitable chain extenders for the further polymerization in aqueous medium are well known in the art. Selected examples include ethylene diamine, diethylene triamine, trietheylene tetraamine, propylene diamine, butylene diamine, hexamethylene diamine, cyclohexylene diamine, piperazine, tolylene diamine, xylylene diamine and isophorone diamine.

Useful polyurethanes include aromatic polyether polyurethanes, aliphatic polyether polyurethanes, aromatic polyester polyurethanes, aliphatic polyester polyurethanes, aromatic polycaprolactam polyurethanes, aliphatic polycaprolactam polyurethanes and acrylic urethane copolymers. Particularly useful polyurethanes include aromatic polyether polyurethanes, aliphatic polyether polyurethanes, aromatic polyester polyurethanes, aliphatic polyester polyurethanes and acrylic urethane copolymers.

Examples of commercial polyurethanes include Sancure 2710® and/or Avalure UR 445® (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 878®, Sancure 8150®, Sancure 1301®, Sancure 2715®, Sancure 1828®, Sancure 2026®, Sancure 1818®, Sancure 853®, Sancure 830®, Sancure 825®, Sancure 776®, Sancure 850®, Sancure 12140®, Sancure 12619®, Sancure 835®, Sancure 843®, Sancure 898®, Sancure 899®, Sancure 1511®, Sancure 1514®, Sancure 1517®, Sancure 1591®, Sancure 2255®, Sancure 2260®, Sancure 2310®, Sancure 2725®, and Sancure 12471® (all of which are commercially available from Noveon, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Neo Resins, NeoRez R-940 (Neo Resins), NeoRez R-960 (Neo Resins), NeoRez R-962 (Neo Resins), NeoRez R-966 (Neo Resins), NeoRez R-967 (Neo Resins), NeoRez R-972 (Neo Resins), NeoRez R-9409 (Neo Resins), NeoRez R-9637 (Neo Resins), NeoRez R-9649 (Neo Resins), and NeoRez R-9679 (Neo Resins).

Particularly useful polyurethanes are aliphatic polyether polyurethanes. Examples of such aliphatic polyether polyurethanes include Sancure 2710® and/or Avalure UR 445®, Sancure 878®, NeoRez R-600, NeoRez R-966, NeoRez R-967, and Witcobond W-320.

In one embodiment, polyurethane (A) is polyester polyurethane. Examples of these binder include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company ICI, and the acrylic copolymer dispersion sold under the name “Neocryl XK-90” by the company Neo Resins.

In one embodiment, polyurethane (A) may be an aliphatic acrylic urethane. Suitable acrylic/urethane copolymers are those that are capable of forming stable dispersions in water. In one embodiment, the urethane/acrylic copolymers are aliphatic acrylic/urethane copolymers. Typically, stability is accomplished with the use of a stabilizer such as ammonia or triethylamine, for example, which interacts with the acid groups in the polymer. Acrylic/urethane copolymers are commercially available and include Sancure® AU-4000 (commercially available from Noveon), Sancure® AU-401® (Noveon), Witcobond A-100 (commercially available from Witco Performance Chemicals, Houston, Tex.), Witcobond W-610 (Witco Performance Chemicals), NeoPac R-9000 (commercially available from NeoResins, Inc.), NeoPac R-9030, and NeoPac R-9699. These materials are oligomers, such as Ebecryl® 8806, having an average molecular weight of about 2,000 and a viscosity of about 10,500 centipoise, at 150.degree. F. and manufactured and sold by Radcure Specialties, Inc. and Photomer® 6210 an aliphatic acrylic urethane oligomer having a molecular weight of about 1400, a viscosity of about 1500 centipoise at about 160° F. and manufactured and sold by Henkel Corporation.

(B) Durability Improving Polymer

The topcoat compositions also contain (B) at least one durability improving polymer. Durability is shown by having improved scratch resistance. A mixture of durability improving polymers may be used. In one embodiment, (B) includes polyacryls, polymethacryls, thermoplastic polymers of ethylene and propylene, polyesters, polyamides, vinyl acetate homopolymers and co- or terpolymers, styrene-acryl copolymer and combinations and blends of two or more thereof. Typically (B) is present in an amount from about 5% to about 95%, or from about 25% to about 70%, or from about 30% to about 70%, or from about 30% to about 65%, or from about 35% to about 55% by weight of the solids of the coating composition.

In one embodiment, (B) includes polyurethanes, polyacryls, polymethacryls, and mixtures thereof. As used herein, a “polyacryl” includes a polyacrylate, polyacrylic, or polyacrylamide. As used herein, a “polymethacryl” includes a polymethacrylate, polymethacrylic, or polymethacrylamide.

In another embodiment, (B) is a polyacryl or polymethacryl resin. As used herein, a “polyacryl” includes polyacrylates, polyacrylics, or polyacrylamides, and “polymethacryl” includes polymethacrylates, polymethacrylics, or polymethacrylamides. These resins includes those derived from acrylic acid, acrylate esters, acrylamide, methacrylic acid, methacrylate esters, and methacrylamide. The acrylate and methacrylate ester generally contain from 1 to about 30 carbon atoms in the pendant group, or from 1 to about 18, or from 2 to about 12 carbon atoms in the pendant group.

Examples of commercial polyacryls and polymethacryls include Gelva® 2497 (commercially available from Monsanto Co., St. Louis, Mo.), Duraplus® 2 (commercially available from Rohm & Haas Co., Philadelphia, Pa.), Joncryl® 95 (commercially available from S.C. Johnson Polymer, Sturtevant, Wis.), SCX-1537 (S.C. Johnson Polymer), SCX-1959 (S.C. Johnson Polymer), SCX-1965 (S.C. Johnson Polymer), Joncryl® 530 (S.C. Johnson Polymer), Joncryl® 537 (S.C. Johnson Polymer), Glascol LS20 (commercially available from Allied Colloids, Suffolk, Va.), Glascol C37 (Allied Colloids), Glascol LS26 (Allied Colloids), Glascol LS24 (Allied Colloids), Glascol LE45 (Allied Colloids), Carboset® CR760 (commercially available from Noveon, Cleveland, Ohio), Carboset® CR761 (Noveon), Carboset® CR763 (Noveon), Carboset® 765 (Noveon), Carboset® 19X2 (Noveon), Carboset® XL28 (Noveon), Carboset® XPD-2111 (Noveon), Hycar 26084 (Noveon), Hycar 26091 (Noveon), Carbobond 26373 (Noveon), Acrygen™ 3760 (Omnova Solutions, Chester, S.C.), Acrygen™ 84128 (Omnova), Acrygen™ 3045 (Omnova), Neocryl® 5090 (commercially available from Neo Resins) Neocryl® A-612 (Neo Resins), Neocryl® A-6044 (Neo Resins), Neocryl® A-622 (Neo Resins), Neocryl® A-623 (Neo Resins), Neocryl® A-634 (Neo Resins), and Neocryl® A-640 (Neo Resins).

In another embodiment, (B) is a thermoplastic copolymer or terpolymer derived from ethylene or propylene and a functional monomer selected from the group consisting of alkyl acrylate, acrylic acid, alkyl acrylic acid, and combinations of two or more thereof. In one embodiment, the functional monomer is selected from alkyl acrylate, acrylic acid, alkyl acrylic acid, and combinations of two or more thereof. The alkyl groups in the alkyl acrylates and the alkyl acrylic acids typically contain 1 to about 8 carbon atoms, and, in one embodiment, 1 to about 2 carbon atoms. The functional monomer(s) component of the copolymer or terpolymer ranges from about 1 to about 15 mole percent, and, in one embodiment, about 1 to about 10 mole percent of the copolymer or terpolymer molecule. Examples include: ethylene/methyl acrylate copolymers; ethylene/ethylacrylate copolymers; ethylene/butyl acrylate copolymers; ethylene/methacrylic acid copolymers; ethylene/acrylic acid copolymers; anhydride-modified low density polyethylenes; anhydride-modified linear low density polyethylene, and mixtures of two or more thereof.

In one embodiment, (B) is characterized by the absence of ethylene vinyl actetate resins, and acid or acid/acrylate-modified ethylene vinyl acetate resins.

Ethylene acid copolymers are available from DuPont under the tradename Nucrel can also be used. These include Nucrel 0407, which has a methacrylic acid content of 4% by weight and a melting point of 109° C., and Nucrel 0910, which has a methacrylic acid content of 8.7% by weight and a melting point of 100° C. The ethylene/acrylic acid copolymers available from Dow Chemical under the tradename Primacor are also useful. These include Primacor 1430, which has an acrylic acid monomer content of 9.5% by weight, a melting point of about 97 C and a T_{g} of about −7.7° C. The ethylene/methyl acrylate copolymers available from Chevron under the tradename EMAC can be used. These include EMAC 2205, which has a methyl acrylate content of 20% by weight and a melting point of 83 C, and EMAC 2268, which has a methyl acrylate content of 24% by weight, a melting point of about 74° C. and a T_{g} of about −40.6° C.

In another embodiment, (B) is a polyester. The polyester may be one or more of those disclosed for preparing the above polyurethanes. In another embodiment, polyesters are prepared from various glycols or polyols and one or more aliphatic or aromatic carboxylic acids also are useful film materials.

Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from duPont is Selar PT-8307 which is polyethylene terephthalate.

In another embodiment, (B) is a homopolymer or copolymer of vinyl acetate. Examples of these polymers include polyvinyl acetate, polyethylene vinyl acetate, acrylic acid or acrylate-modified ethylene vinyl acetate resins, acid-, anhydride- or acrylate-modified ethylene/vinyl acetate copolymers; acid- or anhydride-modified ethylene/acrylate copolymers. Examples of commercially available copolymers and terpolymers that can be used include the ethylene/vinyl acetate copolymers available from DuPont under the tradename Elvax. Other examples of commercially available EVA resins are available from Air Products & Chemicals, Inc., Allentown, Pa., under the AIRFLEX trademark. Examples include AIRFLEX 465® (65% solids) and AIRFLEX 7200® (72-74% solids). Another suitable EVA emulsion polymer is AIRFLEX 426®, a high solids, carboxylated, EVA polymer partially functionalized with carboxyl groups. It is believed that the AIRFLEX brand EVA emulsion polymers are stabilized with up to about 5% by weight polyvinyl alcohol (PVOH) and/or, in some formulations, a nonionic surfactant.

Examples of commercially available copolymers and terpolymers that can be used include the ethylene/vinyl acetate copolymers available from DuPont under the tradename Elvax. These include Elvax 3120, which has a vinyl acetate content of 7.5% by weight and a melting point of 99° C., Elvax 3124, which has a vinyl acetate content of 9% by weight and a melting point of 77° C., Elvax 3150, which has a vinyl acetate content of 15% by weight and a melting point of 92° C., Elvax 3174, which has a vinyl acetate content of 18% by weight and a melting point of 86° C., Elvax 3177, which has a vinyl acetate content of 20% by weight and a melting point of 85° C., Elvax 3190, which has a vinyl acetate content of 25% by weight and melting point of 77° C., Elvax 3175, which has a vinyl acetate content of 28% by weight and a melting point of 73° C., Elvax 3180, which has a vinyl acetate content of 28% by weight and a melting point of 70° C., Elvax 3182, which has a vinyl acetate content of 28% by weight and a melting point of 73° C., and Elvax 3185, which has a vinyl acetate content of 33% by weight and a melting point of 61° C., and Elvax 3190LG, which has a vinyl acetate content of 25% by weight, a melting point of about 77° C. and a glass transition temperature (T_{g}) of about −38.6° C. Commercial examples of available polymers include Escorene UL-7520, a copolymer of ethylene with 19.3% vinyl acetate (Exxon).

In one embodiment, (B) is a terpolymer or copolymer of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillip Petroleum Co. KR-10 is believed to be a copolymer of styrene with 1,3-butadiene. Another useful polystyrene is a copolymer of styrene and an alkyl acrylate in which the alkyl moiety has 1 to 6 carbon atoms. Butyl acrylate is especially useful as the comonomer of styrene. One particular commercially available source of the copolymer is the styrene/butyl acrylate copolymer dispersion available under the Trade-mark ACRONAL S312D, S320D and S305D from BASF.

In one embodiment, (B) is a styrene-acryl copolymer. The acryl component is describe above. In one embodiment, the acryl may be an acrylic acid or ester, an acrylonitrile or their methacrylic analogs. Examples of the these resins include Microgel E-1002, E-2002, E-5002 (styrene acryl resin emulsion, available from Nippon Paint Co., Ltd.), Voncoat 4001 (acryl emulsion, available from Dainippon Ink & Chemicals, Inc.), Voncoat 5454 (styrene acryl resin emulsion, available from Dainippon Ink & Chemicals, Inc.), SAE 1014 (styrene acryl resin emulsion, available from Nippon Zeon Co., Ltd.), Saivinol SK-200 (acryl resin emulsion, available from Saiden Chemical Industry Co., Ltd.), Nanocryl SBCX-2821 (silicone-modified acryl resin emulsion, available from Toyo Ink Mfg. Co., Ltd.), Nanocryl SBCX-3689 (silicone-modified acryl resin emulsion, available from Toyo Ink Mfg. Co., Ltd.), #3070 (methacrylic acid methyl polymer resin emulsion, available from Mikuni Color Limited), SG-60 (styrene-acryl resin emulsion, available from Gifu Ceramic Co., Ltd.), and Grandol PP-1000 (Styrene-acryl resin emulsion, available from Dainippon Ink & Chemicals, Inc.).

In another embodiment, the topcoat compositions comprise a mixture of two or more acrylic urethanes. The acrylic urethanes are discussed above. For instance the topcoat composition may be a mixture of NeoPac 9000 and NeoPac 9699. The mixtures may vary independently by the proportions given for the mixtures of the polyurethane (A) and the durability improving polymer (B). In one embodiment, the acrylic urethance are present in a ratio of 0.25 to about 2, or from about 0.5 to about 1.5, or about 0.75 to about 1.25 to 1. In another embodiment, the mixture of the acrylic urethanes further comprises one or more of the durability improving polymer (B). In this embodiment, the mixture of acrylic urethanes is generally present in an amount from about 35% to about 99%, or from 45% to about 95%, or from about 55% to about 90% by weight of the solids of the mixture. The durability polymer (B) is generally present in an amount from about 1% to about 65%, or from about 5% to about 55%, or from about 10% to about 50% by weight of the solids of the mixture. In one embodiment, the polymer (B) is present in an minor amount, such as amounts form about 2% to about 40%, or from about 5% to about 30%, or from about 8% to about 20% by weight of the solids of the mixture.

Other additives can be added as well to obtain a certain desired characteristic, such as waxes, defoamers, surfactants, colourants, anti-oxidants, UV stabilizers, luminescents, cross-linkers etc. In one embodiment, the topcoat composition contains anti-blocking additives. These additives reduce the tendency of the film to stick together when it is in roll form. The antiblock additives include natural silica, diatomaceous earth, synthetic silica, glass spheres, ceramic particles, etc. The slip additives include primary amides such as stearamide, behenamide, oleamide, erucamide, and the like; secondary amides such as stearyl erucamide, erucyl erucamide, oleyl palimitamide, stearyl stearamide, erucyl stearamide, and the like; ethylene bisamides such as N,NN-ethylenebisstearamide, N,NN-ethylenebisolamide and the like; and combinations of any two or more of the foregoing amides. An example of a useful slip additive is available from Ampacet under the trade designation 10061; this product is identified as a concentrate containing 6% by weight of a stearamide slip additive. The antiblock and slip additives may be added together in the form of a resin concentrate. An example of such a concentrate is available from DuPont under the tradename Elvax CE9619-1. This resin concentrate contains 20% by weight silica, 7% by weight of an amide slip additive, and 73% by weight of Elvax 3170 (a product of DuPont identified as an ethylene/vinyl acetate copolymer having a vinyl acetate content of 18% by weight). Antiblocking additives are known to those in the art. An example of a use anti-blocking agent is Tego Glide 482 available from Tego Chemie. The antiblock additive can be used at a concentration in the range of up to about 1% by weight, and in one embodiment about 0.01% to about 0.5% by weight. The slip additive can be used at a concentration in the range of up to about 1% by weight, and in one embodiment about 0.01% to about 0.5% by weight.

In one embodiment, the topcoat compositions are free of one or more of the following materials: absorbent particles, cellulose and cellulose derived polymers and particles, polyvinyl alcohol, polyalkylneoxides such as polyethyleneoxide, and polyvinyl pyrrolidinone The topcoat compositions are coated onto the substrate. It should be noted these substrates may be individual paper or film face stocks or may also be multilayer constructions. The multilayer constructions may be coextruded or laminated articles which are useful for printing applications. These articles include those that have adhesive layers. These articles are useful as label and graphic stocks.

The topcoat compositions can be coated onto substrates in various manners, for instance by means of engraving coating, off-set coating, a casting process or by (co)extrusion. The choice for a certain production method depends strongly on the raw material characteristics and on the desired thickness of the coating. The substrates may only have a portion or portions of their surface coated with the topcoat compositions.

Drying of a water or diluent based system can be done by the usual thermal drying techniques, by means of microwaves or infrared drying. Solventless systems can be cured thermally, by means of UV curing or Electron Beam curing.

The coating is typically applied in the following manner. A coating composition is applied to a film or paper by means of techniques known in the industry. In a ventilated oven, the diluent or water is evaporated, after which a top layer with the desired thickness is obtained. If desired one or more layers between the film or paper and the coating can be provided. These may serve to obtain certain desired additional characteristics, such as a desired color, opacity etc.

When the composite film or paper according to the invention has to be used as a label, the film or paper can be provided with an adhesive layer at the side that is not covered with the topcoat. This adhesive layer may consist of a pressure sensitive adhesive or a heat activated adhesive. All adhesives can be used including acrylic and rubber based adhesives. Additionally the film or paper can be used without an adhesive layer, being the case in inmold-labeling. A primer coating may be used to improve adhesive to between the substrate and the topcoat.

The following examples relate to coating compositions and their preparation. These examples are illustrative and not intended to be limiting in scope. Unless otherwise indicated, the temperature is ambient temperature, the pressure is atmospheric pressure, amounts are by weight and the temperature is in degrees Celsius.

### EXAMPLE 1

A reaction vessel is charged with 100 parts of water. Then, 45 parts of NEOCRYL 5090 acrylic polymer dispersion (45% solids) is added to the vessel with stirring. Thereafter, 50 parts of HD 4664 polyurethane dispersion from Hauthane (50% solids) is added with stirring. The mixture is stirred for an additional three minutes to yield a coating composition having 45% solids.

### EXAMPLE 2-10

The following table contain further examples of coating compositions. These coating compositions are prepared as described in Example 1.

| | 2 | 3 | 4 | 5 | 6 | 7 | 8 |
|---|---|---|---|---|---|---|---|
| Polyurethanes (A) | | | | | | | |
| HD 4664 | — | 50 | — | 45 | 60 | — | — |
| (50% solids) | | | | | | | |
| Neo Rez R9679 | 55 | — | 58 | — | — | 55 | 58 |
| (37% solids) | | | | | | | |
| Polymers (B) | | | | | | | |
| Neocryl 5090 | 45 | — | — | 55 | — | — | — |
| (45% solids) | | | | | | | |
| Sancure 2255 | — | 50 | — | — | — | — | 42 |
| (49% solids) | | | | | | | |
| Joncryl 95 | — | — | 42 | — | — | — | — |
| (30% solids) | | | | | | | |
| Carboset GA 1604 | — | — | — | — | 40 | — | — |
| (42% solids) | | | | | | | |
| Paraloid A-646 | — | — | — | — | — | 45 | — |
| (45.6% solids) | | | | | | | |
| Water | 100 | 100 | 100 | 100 | 100 | 100 | 100 |

| | | | | | | | | | | | | | |
|---|---|---|---|---|---|---|---|---|---|---|---|---|---|
| Polyurethane (A) | % | 9 | 10 | 11 | 12 | 13 | 14 | 15 | 16 | 17 | 18 | 19 | 20 |
| | Solids | | | | | | | | | | | | |
| HD 4664 | 50 | 88.2 | 72 | | | | | | | | | | |
| NeoRez R-600 | 33 | | | | | | | 11.1 | | | | | |
| NeoPac R-9000 | 40 | | | 80 | 53.8 | 11 | 25.6 | 48.7 | 53.6 | 45 | 45 | 49.4 | 49.8 |
| NeoPac R-9699 | 40 | | | | | | | | | 45 | | 48.8 | 50 |
| NeoPac R-9649 | | | | | | | | | | | 45 | | |
| Polymers (B) | | | | | | | | | | | | | |
| Neocry 5090 | 45 | 10.9 | 26.7 | 17.8 | | | | | | 10 | 10 | | |
| Acrygen 84124 | 45 | | | | 28.7 | 88 | 46 | 39 | 28.7 | | | | |
| Hycar 26138 | 50 | | | | | | 27.6 | | | | | | |
| Carboset XPD-2111 | 43 | | | | 17.2 | | | | 17.2 | | | | |
| Other | | | | | | | | | | | | | |
| Water | | 0.9 | 1.3 | 2.2 | 0.4 | 1.0 | 1.7 | 1.1 | 0.4 | | | 1.6 | 0.1 |
| Tego Glide 482 | | | | | | | | | 0.2 | | 0.1 | 0.2 | 0.1 |

Overlaminated Product

The ink printed substrate may have an overlaminate. The overlaminate layer refers to any sheet material that can be adhered to the surface of any existing coated or uncoated sheet material. “Overlamination” refers to any process of achieving this adherence, particularly without the entrapment of air bubbles, creases or other defects that might spoil the appearance of the finished article or image. The deleterious effects of ambient humidity may be slowed by the overlamination of a transparent protective coat or sheet herein referred to as an overlaminate. Overlamination has the further advantage that the images are protected from scratching, splashes, and the overlaminate can supply a high gloss finish or other desired surface finish or design, and provide a degree of desired optical dot-gain. The overlaminate layer may also absorb ultraviolet radiation or protect the underlayers and image from deleterious effects of direct sunlight or other sources of radiations. Overlamination is, for example, described in U.S. Pat. No. 4,966,804. This patent is incorporated herein by reference.

After printing an image or design onto the receptor layers of the present invention, the image is overlaminated with a transparent colorless or nearly colorless material. Suitable overlaminate layers include any suitable transparent plastic material bearing on one surface an adhesive. The adhesive of the overlaminate layer could be a hot-melt or other thermal adhesive or a pressure-sensitive adhesive. The surface of the overlaminate layer can provide high gloss or matte or other surface texture. The overlaminate layers are designed for external graphics applications and include materials such as those commercially available from Avery Dennison as DOL 1000 or DOL 4000 Digital Overlaminate.

The overlaminate protective layer can be comprised of a thermoplastic film and a pressure sensitive or heat-activatable adhesive adhered to one side of the film. The thermoplastic film of the overlaminate protective layer may have a single layer or a multilayered structure. It can be comprised of a thermoplastic polymer that can be: a polyolefin; an ionomer resin derived from sodium, lithium or zinc and ethylene/methacrylic acid copolymers; an ethylene acrylic or methacrylic acid copolymer; an ethylene-vinylacetate terpolymer wherein the termonomer is acrylic acid, methyl acrylate or maleic anhydride; a polymethylmethacrylate; or a polyester.

The polyolefins that can be useful include polyethylene, polypropylene or polybutylene or copolymers of ethylene, propylene or butylene with an alpha olefin. The alpha olefin, is selected from those alpha olefins containing from 2 to about 18 carbon atoms, and in one embodiment 2 to about 12 carbon atoms, and in one embodiment 2 to about 8 carbon atoms including ethylene, butylene, hexene and octene. Medium density polyethylenes and the linear medium density polyethylenes are useful. Useful polyolefins include those prepared using a Ziegler-Natta catalyst or a metallocene catalyst. An example of the useful polyolefin is available from Dow Chemical under the trade designation Affinity 1030HF, which is identified as a metallocene catalyst catalyzed octene-ethylene copolymer.

The ionomer resins available from DuPont under the tradename Surlyn can be used. These resins are identified as being derived from sodium, lithium or zinc and copolymers of ethylene and methacrylic acid. Included in this group are: Surlyn 1601, which is a sodium containing ionomer; Surlyn 1605, which is a sodium containing ionomer; Surlyn 1650, which is a zinc containing ionomer; Surlyn 1652, which is a zinc containing ionomer; Surlyn 1702, which is a zinc containing ionomer; Suryin 1705-1, which is a zinc containing ionomer; Surlyn 1707, which is a sodium containing ionomer; Surlyn 1802, which is a sodium containing ionomer; Surlyn 1855, which is a zinc containing ionomer; Surlyn 1857, which is a zinc containing ionomer; Surlyn 1901, which is a sodium containing ionomer; Surlyn AD-8546, which is a lithium containing ionomer; Surlyn AD-8547, which is a zinc containing ionomer; Surlyn AD-8548, which is a sodium containing ionomer; Surlyn 7930, which is a lithium containing ionomer; Surlyn 7940, which is a lithium containing ionomer; Surlyn 8020, which is a sodium containing ionomer; Surlyn 8140, which is a sodium containing ionomer; Surlyn 8528, which is a sodium containing ionomer; Surlyn 8550, which is a sodium containing ionomer; Surlyn 8660, which is a sodium containing ionomer; Surlyn 8920, which is a sodium containing ionomer; Surlyn 8940, which is a sodium containing ionomer; Surlyn 9120, which is a zinc containing ionomer; Surlyn 9650, which is a zinc containing ionomer; Surlyn 9730, which is a zinc containing ionomer; Surlyn 9910, which is a zinc containing ionomer; Surlyn 9950, which is a zinc containing ionomers; and Surlyn 9970, which is a zinc containing ionomer.

The ethylene acrylic or methacrylic acid copolymers that can be used include those available from DuPont under the tradename Nucrel. These include Nucrel 0407, which has a methacrylic acid content of 4% by weight and a melting point of 109° C., and Nucrel 0910, which has a methacrylic acid content of 8.7% by weight and a melting point of 100C. The ethylene/acrylic acid copolymers available from Dow Chemical under the tradename Primacor are also useful. These include Primacor 1430, which has an acrylic acid monomer content of 9.5% by weight and melting point of 97° C.

The concentration of the thermoplastic polymer in the thermoplastic film of the overlaminate protective film layer is generally at least about 30% weight, and in one embodiment about 30% to about 99.5% weight, and in one embodiment about 75% to about 99.5% by weight.

The thermoplastic film of the overlaminate protective layer may, and often does, contain a UV light absorber or other light stabilizer.

Hindered amine light stabilizers are described in the literature such as in U.S. Pat. No. 4,721,531, columns 4 to 9, which is incorporated herein by reference. The hindered amine light stabilizers may, for example, be derivatives of 2,2,6,6-tetraalkyl piperidines or substituted piperizinediones. Among the UV light absorbers that are useful are the hindered amine absorbers available from Ciba-Geigy under the trade designation Tinuvin, especially those available under the designations Tinuvin 234, Tinuvin 326, Tinuvin 327 and Tinuvin 328. The light stabilizers that can be used include the hindered amine light stabilizers available from Ciba-Geigy under the trade designations Tinuvin 111, Tinuvin 123, Tinuvin 622, Tinuvin 770 and Tinuvin 783. Also useful light stabilizers are the hindered amine light stabilizers available from Ciba-Geigy under the trade designation Chimassorb, especially Chimassorb 119 and Chimassorb 944. The concentration of the UV light absorber and/or light stabilizer in the thermoplastic film composition is in the range of up to about 2.5% by weight, and in one embodiment about 0.05% to about 1% by weight.

A useful stabilizer is available under the tradename Ampacet 10561 which is a product of Ampacet identified as a UV stabilizer concentrate containing 20% by weight of a UV stabilizer and 80% by weight of a low density polyethylene carrier resin; the UV stabilizer in this product is Chemissorb 944. Useful light stabilizers are also provided in Ampacet 150380 and Ampacet 190303, both of which are pigment concentrates discussed above. Ampacet 150380 has a UV stabilizer concentration of 7.5% by weight. Ampacet 190303 has a UV stabilizer concentration of 4% by weight. The UV stabilizer in each of these products is Chemissorb 944. Ampacet LR-89933 is a grey concentrate having a UV stabilizer concentration of 4.5% by weight, the UV stabilizer being Tinuvin 783.

The thermoplastic film of the overlaminate protective layer may contain an antioxidant. Any antioxidant useful in making thermoplastic films can be used. These include the hindered phenols and the organo phosphites. Examples include those available from Ciba-Geigy under the trade designations Irganox 1010, Irganox 1076 or Irgafos 168. The concentration of the antioxidant in the thermoplastic film composition is in the range of up to about 2.5% by weight, and in one embodiment about 0.05% to about 1% by weight.

The thermoplastic film of the overlaminate protective layer may contain a metal deactivator. Any metal deactivator useful in making thermoplastic films can be used. These include the hindered phenol metal deactivators. Examples include those available from Ciba-Geigy under the trade designation Irganox 1024. The concentration of the metal deactivator in the thermoplastic film composition is in the range of up to about 1% by weight, and in one embodiment about 0.2% to about 0.5% by weight.

The thickness of the thermoplastic film of the overlaminate protective layer is generally in the range of about 0.5 to about 5 mils, and in one embodiment about 1 to about 3 mils. The pressure sensitive or heat-activatable adhesive that is adhered to the thermoplastic film of the overlaminate protective layer may be any of the pressure sensitive or heat-activatable adhesives. An especially useful pressure sensitive adhesive is Aeroset 1460. An especially useful heat-activatable adhesive is Elvax 3185. The pressure sensitive or heat-activatable adhesive may be blended with one or more of the UV light absorbers, light stabilizers, antioxidants and/or metal deactivators described above as being useful in making the thermoplastic film of the overlaminate protective film layer. These additive materials are typically added to the pressure sensitive or heat-activatable adhesive composition at concentrations of up to about 2.5% by weight for each of the additive materials based on the overall weight of the pressure sensitive or heat-activatable adhesive composition, and in one embodiment about 0.05 to about 1% by weight.

The thickness of the pressure sensitive or heat-activatable adhesive of the overlaminate protective layer is generally in the range of about 0.25 mil to about 2 mils, and in one embodiment about 0.5 mil to about 1 mil. In one embodiment, the coat weight of this pressure sensitive or heat-activatable adhesive is generally in the range of about 10 gsm to about 50 gsm, and in one embodiment about 20 gsm to about 35 gsm.

The overlaminate protective layer is adhered to the ink receptive sheet by contacting the film layer and the sheet using known techniques. The pressure sensitive or heat-activatable adhesive of the overlaminate protective layer contacts the sheet and adheres the film layer to the laminate.

Prior to adhering the overlaminate protective layer to the sheet, the overlaminate protective layer may be provided with a release liner overlying its pressure sensitive adhesive layer. The use of the release liner facilitates the handling of the overlaminate protective layer. During the step of adhering the overlaminate protective layer to the laminate, the release liner is stripped from the overlaminate protective layer, thus exposing the pressure sensitive adhesive. Any release liners can be used.

Alternatively, the first surface of the overlaminate protective layer can be release coated to permit a self-wound roll structure, wherein the pressure sensitive or heat-activatable adhesive coated second surface of the overlaminate protective layer is wound in contact with the release coated first surface of said overlaminate protective layer. The release coating composition can be any release coating composition known in the art. Silicone release coating compositions are useful, and any of the silicone release coating compositions which are known in the art can be used. The major component of the silicone release coating is a polyorganosiloxane and more often, polydimethylsiloxane. The silicone release coating compositions used in this invention may be room temperature cured, thermally cured, or radiation cured. Generally, the room temperature and thermally curable compositions comprise at least one polyorganosiloxane and at least one catalyst (of curing agent) for such polyorganosiloxane(s). Such compositions may also contain at least one cure accelerator and/or adhesion promoter (sometimes referred to as an anchorage additive). As is known in the art, some materials have the capability of performing both functions, i.e., the capability of acting as a cure accelerator to increase the rate, reduce the curing temperature, etc., and also as an adhesion promoter to improve bonding of the silicone composition to the substrate. The use of such dual function additives where appropriate is within the purview of the invention.

The release coating compositions are applied to the overlaminate protective layer using known techniques. These include gravure, reverse gravure, offset gravure, roller coating, brushing, knife-over roll, metering rod, reverse roll coating, doctor knife, dipping, die coating, spraying curtain coating, and the like. The coat weight is in the range of about 0.1 grams per square meter (gsm) to about 10 gsm or more, and in one embodiment about 0.3 gsm to about 2 gsm. In one embodiment, the thickness or caliper of the resulting release-coated substrate may range from 5 about 0.5 mil to about 10 mils, and in one embodiment from about 1 mil to about 6 mils.

The following examples relates to overlaminates which may be used in the present invention.

### EXAMPLE O-1

An overlaminate includes

Face Film: 2.1 mil clear, high gloss, premium cast vinyl film

Avery Dennison Adhesive: s-652 permanent, clear, acrylic, pressure-sensitive

Release Liner: 78# Bleached Kraft

### EXAMPLE O-2

An overlaminate includes

Face Film: 2.1 mil clear, matte, premium, cast vinyl film

Avery Dennison Adhesive: S-652 permanent, clear, acrylic, pressure-sensitive

Release Liner: 78# Bleached Kraft

### EXAMPLE O-3

An overlaminate includes

Face Film: 3.1 flexible, clear, semi-gloss calendered vinyl film

Avery Dennison Adhesive: S-652 permanent, clear, acrylic, pressure-sensitive

Release Liner: 78# Bleached Kraft

### EXAMPLE O-4

An overlaminate includes

Face Film: 1.0 mil clear, high gloss, premium, cast fluoropolymer DuPont Teflon film

Avery Dennison Adhesive: S-659 permanent, clear, acrylic, pressure-sensitive

Release Liner: 78

The following examples relate to the ink printable article of the present invention.

### EXAMPLE A

a) Ink printable articles useful for wide format thermal and piezo ink jet printers are prepared by coating 3.4 mil flexible white calendered vinyl films with each of the products of Example 1-16 on one surface. To each these products are laminated a Avery Dennison S-652 permanent, clear, acrylic pressure-sensitive adhesive on a 90# StaFlat liner. The adhesive is placed on the opposite side of the film than the ink receptive coating.

b) Products of part a) are printed with ink jet image and these product is overlaminated with the overlaminate of Example 0-1.

### EXAMPLE B

a) Ink printable articles useful as with wide format thermal and piezo ink jet printers, are prepared as described in Example A using a 3.4 mil flexible white calendered vinyl film, Avery Dennison R-196 removable, clear, acrylic pressure-sensitive adhesive, and 90# StaFlat release liner.

b) Products of part a) are printed with ink jet images and these products are overlaminated with the overlaminate of Example 0-2.

### EXAMPLE C

a) Ink printable articles useful with wide format thermal and piezo ink jet printers are prepared as described in Example A using, 7 mil DuPont Tejin Film Melinex translucent base materials which are coated with each of the product of Examples 1-16.

b) The products of part a) are printed with ink jet images and these products are overlaminated with the overlaminates of Example 0-2.

### EXAMPLE D

a) Ink printable articles useful with wide format thermal and piezo ink jet printers are prepared as described in Example A using, 4 mil DuPont Tejin Film Melinex polyester base materials which are coated with each of the products of Example 1-16.

b) The products of part a) are printed with ink jet images and these products are overlaminated with the overlaminates of Example 0-2.

### EXAMPLE E

a) Ink printable articles useful with wide format thermal and piezo ink jet printers are prepared as described in Example A using 9 mil flexible white polyolefin films which are coated with each of the products of Example 1-16.

b) The products of part a) are printed with ink jet images and these products are overlaminated with the overlaminates of Example 0-2.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A topcoat composition comprising (i) a mixture of (A) at least one polyurethane and (B) at least one durability improving polymer, (ii) a mixture of two or more acrylic urethanes, or (iii) a combination of (i) and (ii).

2. The composition of claim 1 wherein (A) is an aliphatic or aromatic polyurethane.

3. The composition of claim 1 wherein (A) is a polyester polyurethane, a polyether polyurethane, an acrylic urethane, a polycarbonate polyurethane, a polythioether polyurethane, a polyesteramide polyurethane or mixtures of two or more thereof.

4. The composition of claim 1 wherein (A) is a polyester polyurethane.

5. The composition of claim 1 wherein (A) is an acrylic urethane.

6. The topcoat composition of claim 1 wherein (A) is present in an amount of at least 5% to about 95% by weight of the solids present in the coating composition.

7. The composition of claim 1 wherein (B) is a polyacryl, polymethacryl, a thermoplastic polymer of ethylene or propylene, a polyester, a styrene acryl copolymer and mixtures of two or more thereof.

8. The composition of claim 1 wherein (B) is a polyacryl or a polymethacryl.

9. The composition of claim 1 wherein (B) is a copolymer of an olefin and acrylic or methacrylic acid or ester.

10. The composition of claim 1 wherein (B) is a copolymer of an olefin and a vinyl carboxylate.

11. The composition of claim 1 wherein (B) is present in an amount from about 5% to about 95% by weight of the solids present in the topcoat.

12. A topcoat composition comprising (A) at least one polyether urethane; polyester polyurethane; acrylic urethane copolymer; or mixtures of two or more thereof and (B) at least one polyacryl, polymethacryl, thermoplastic polymer of ethylene or propylene, polyester, styrene acryl copolymer and mixtures of two or more thereof.

13. The composition of claim 12 wherein (A) is a aliphatic polyester polyurethane.

14. The composition of claim 12, wherein (A) is a acrylic urethane copolymer.

15. The composition of claim 12 wherein (A) is a blend of an aliphatic polyurethane and an acrylic urethane copolymer.

16. The composition of claim 12 wherein (B) is a polyacryl or a polymethacryl.

17. The composition of claim 12 wherein (B) is a copolymer of an olefin or an acrylic or methacrylic acid or esters.

18. A topcoat composition comprising a combination of two or more acrylic urethanes.

19. The topcoat of claim 18 further comprising (B) at least one durability improving polymer.

20. The composition of claim 19 wherein (B) is a polyacryl, polymethacryl, a thermoplastic polymer of ethylene or propylene, a polyester, a styrene acryl copolymer and mixtures of two or more thereof.

21. An ink receptive sheet comprising a substrate having a topcoat derived from the topcoat composition of claim 1 on at least one of its surfaces.

22. The ink receptive sheet of claim 21 wherein the substrate is a paper or a film based substrate.

23. The ink receptive sheet of claim 21 wherein the substrate is a polyolefin film, polyester film, polyamide film, or a polyurethane film.

24. An ink receptive sheet comprising a substrate having a topcoat derived from the topcoat composition of claim 12 on at least one of its surfaces.

25. The ink receptive sheet of claim 24 wherein the substrate is a paper or a film based substrate.

26. The ink receptive sheet of claim 24 wherein the substrate is a polyolefin film, polyester film, polyamide film, or a polyurethane film.

27. An ink receptive sheet comprising a substrate having a topcoat derived from the topcoat composition of claim 18 on at least one of its surfaces.

28. The ink receptive sheet of claim 27 wherein the substrate is a paper or a film based substrate.

29. The ink receptive sheet of claim 27 wherein the substrate is a polyolefin film, polyester film, polyamide film, or a polyurethane film.

30. The method of printing comprising the steps of (1) providing a printable substrate having at least one surface coated with a coating derived from a topcoat composition of claim 1, (2) printing on the topcoat composition with a non-vented printer using a solvent based inkjet ink or UV inkjet ink.
